(19) United States
(12) Patent Application Publication
(10) Pub. No.: US 2003/0128956 A1
(43) Pub. Date: Jul. 10, 2003

(54) Optical polymer blends with adjustable refractive index and optical waveguides using same

(75) Inventors: Jaya Sharma, West Chester, PA (US); Anna Panackal, Philadelphia, PA (US); Robert A. Norwood, West Chester, PA (US)

Correspondence Address: MONTE & MCGRAW, PC, 4092 SKIPPACK PIKE, P.O. BOX 650, SKIPPACK, PA, 19474, US

(73) Assignee: Photon-X, Inc., Malvern, PA (US)

(21) Appl. No.: 10/106,482

(22) Filed: Mar. 25, 2002

Related U.S. Application Data
(60) Provisional application No. 60/346,749, filed on Jan. 8, 2002.

(51) Int. Cl. G02B 6/16; C08L 27/12

(52) U.S. Cl. 385/145; 385/143; 385/123; 525/199

(57) ABSTRACT

A polymer blend is provided. The blend includes poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene]. A method of manufacturing the blend is also provided. An optical waveguide and a method of fabricating the optical waveguide using the polymer blend are also provided.

### FIELD OF THE INVENTION

The present invention relates to optical perfluoropolymers which are blended together in predetermined amounts to obtain desired refractive indices as well as waveguides which are fabricated using the blended perfluoropolymers.

### BACKGROUND OF THE INVENTION

Optical waveguides are typically structures that guide light, including both single-mode and multimode propagation. Planar optical waveguides include waveguide cores, which are stripes fabricated in a thin layer, or channel, on top of a substrate, and are surrounded by cladding layers. The cladding layers have lower refractive indices than the waveguide core, so that light propagating through the waveguide core is contained within the waveguide core by total internal reflection.

The fabrication of an optical waveguide requires the ability to form core and cladding regions with refractive indices that differ by a predetermined amount. For multimode waveguides, the refractive index difference is generally large, such as between 0.02 and 0.1. Additionally, the dimensions of the waveguide are also generally relatively large, such as 0.1 mm×0.1 mm. Further, for multimode waveguides, it is not necessary to require a high degree of control over the refractive index difference, as there is little effect on the waveguide performance and properties when the number of modes is large.

On the contrary, for single-mode optical waveguides, the precise differences between the waveguide core refractive index and the cladding refractive indices directly affects several parameters, including, but not limited to, wavelengths at which the waveguide maintains a single mode condition, the optimum size of the waveguide core, and the efficiency of coupling between the waveguide and the optical fiber.

For single-mode optical waveguides to be made, it is critical that both the dimensions of the waveguide be controlled to submicron tolerances, and that the refractive indices of the materials comprising the waveguide be precisely controlled down to 10⁻³ or 10⁻⁴. These conditions are primarily required to assure good coupling to the standard single-mode optical fiber that will be coupled to the waveguide device on the inputs and outputs of the waveguide. At the same time, the materials comprising the waveguide must have low optical absorption and scattering loss. The combination of these various requirements results in significant constraints being placed on the available materials systems for polymer waveguides. For example, two commercially available perfluoropolymers, CYTOP®, a registered trademark of Asahi Glass and TEFLON® AF, a registered trademark of DuPont, are suitable materials for optical waveguides in that they can be made into well controlled submicron structures and have low optical absorption loss. Consider, single-mode waveguides using TEFLON® AF as a cladding layer (n=1.298 at 1550 nanometers) and CYTOP® as a core layer (n=1.334 at 1550 nanometers). The number of modes, υ, that a slab waveguide will support, given that TEFLON® AF is used for both top and bottom cladding layers and the thickness of the cladding layers is sufficient to treat the system as a three layer system, is given by

$$υ = \frac{2 h}{λ} \sqrt{{n}_{core}^{2} - {n}_{clad}^{2}} \qquad Equation 1$$

where h is the thickness of the core layer, λ the wavelength of the light, n_{core} the refractive index of the core (1.334) and n_{clad} the refractive index of the cladding (1.298). Therefore, to achieve υ=1 (with λ=1550 nanometers) requires that h be less than 2.5 μm, which will provide for very poor coupling to single-mode optical fiber with mode field diameters of 8 μm or so. It would be preferable to have a method for varying the core and/or cladding indices of these materials without substantially effecting the other advantageous properties, such as their ability to be formed into uniform thin films, their compatibility with patterning processes, and their low optical loss.

### BRIEF SUMMARY OF THE INVENTION

Briefly, the present invention provides a polymer blend comprising poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene].

Further, the present invention provides a method of manufacturing a polymer blend. The method comprises providing a mixture of perfluoro trialkylamine and perfluoro (2-butyltetrahydrofuran) in approximately a 4 to 1 ratio; combining with the mixture solid poly[2,2-bistrifluoromethyl-4,5-difluoro-1,3-dioxole-co-tetrafluoroethylene] to form a 4.2% by weight poly[2,2-bistrifluoromethyl-4,5-difluoro-1,3-dioxole-co-tetrafluoroethylene] solution; stirring the poly[2,2-bistrifluoromethyl-4,5-difluoro-1,3-dioxole-co-tetrafluoroethylene] solution over heat until the solid completely dissolves; cooling the poly[2,2-bistrifluoromethyl-4,5-difluoro-1,3-dioxole-co-tetrafluoroethylene] solution; filtering the poly[2,2-bistrifluoromethyl-4,5-difluoro-1,3-dioxole-co-tetrafluoroethylene] solution; providing poly[2,2,4-trifluoro-5-trifluoromethoxy-1,3-dioxole-co-tetrafluoroethylene] in perfluoro 2-butyltetrahydrafuran to form a 10.2% by weight poly[2,2,4-trifluoro-5-trifluoromethoxy-1,3-dioxole-co-tetrafluoroethylene] solution; and adding the poly[2,2,4-trifluoro-5-trifluoromethoxy-1,3-dioxole-co-tetrafluoroethylene] solution to the poly[2,2-bistrifluoromethyl-4,5-difluoro-1,3-dioxole-co-tetrafluoroethylene] solution.

Also, the method provides a polymer blend comprising poly[2,2-bistrifluoromethyl-4,5-difluoro-1,3-dioxole-co-tetrafluoroethylene]; and poly[2,2,4-trifluoro-5-trifluoromethoxy-1,3-dioxole-co-tetrafluoroethylene]. The polymer blend is manufactured by providing a mixture of perfluoro trialkylamine and perfluoro(2-butyltetrahydrofuran) in approximately a 4 to 1 ratio; combining with the mixture solid poly[2,2-bistrifluoromethyl-4,5-difluoro-1,3-dioxole-co-tetrafluoroethylene] to form a 4.2% by weight poly[2,2-bistrifluoromethyl-4,5-difluoro-1,3-dioxole-co-tetrafluoroethylene] solution; stirring the poly[2,2-bistrifluoromethyl-4,5-difluoro-1,3-dioxole-co-tetrafluoroethylene] solution over heat until the solid completely dissolves; cooling the poly[2,2-bistrifluoromethyl-4,5-difluoro-1,3-dioxole-co-tetrafluoroethylene] solution; filtering the poly[2,2-bistrifluoromethyl-4,5-difluoro-1,3-dioxole-co-tetrafluoroethylene] solution; providing the poly[2,2,4-trifluoro-5-trifluoromethoxy-1,3-dioxole-co-tetrafluoroethylene] to form a 10.2% by weight poly[2,2,4-trifluoro-5-trifluoromethoxy-1,3-dioxole-co-tetrafluoroethylene] solution; and adding the poly[2,2,4-trifluoro-5-trifluoromethoxy-1,3-dioxole-co-tetrafluoroethylene] solution to the poly[2,2-bistrifluoromethyl-4,5-difluoro-1,3-dioxole-co-tetrafluoroethylene] solution.

The present invention also provides an optical waveguide comprising a substrate and a first cladding layer disposed on the substrate. The first cladding layer includes between greater than zero and up to and including 100 percent of poly[2,2-bistrifluoromethyl-4,5-difluoro-1,3-dioxole-co-tetrafluoroethylene] and a remaining percent poly[2,2,4-trifluoro-5-trifluoromethoxy-1,3-dioxole-co-tetrafluoroethylene], the first cladding layer having a first refractive index. The waveguide also comprises a waveguide core disposed on the substrate. The waveguide core has a second refractive index greater than the first refractive index. The waveguide also comprises a second cladding layer disposed on the waveguide core. The second cladding layer includes between greater than zero and up to and including 100 percent of poly[2,2-bistrifluoromethyl-4,5-difluoro-1,3-dioxole-co-tetrafluoroethylene] and a remaining percent poly[2,2,4-trifluoro-5-trifluoromethoxy-1,3-dioxole-co-tetrafluoroethylene]. The second cladding layer has a third refractive index less than the second refractive index.

Further, the present invention also provides a method of manufacturing an optical waveguide. The method comprises providing a substrate; disposing a first cladding layer onto the substrate, the first cladding layer including between greater than 0% and up to and including 100% poly[2,2-bistrifluoromethyl-4,5-difluoro-1,3-dioxole-co-tetrafluoroethylene] and the remaining poly[2,2,4-trifluoro-5-trifluoromethoxy-1,3-dioxole-co-tetrafluoroethylene], the first cladding layer having a first refractive index; disposing a waveguide core onto the substrate, the waveguide core having a lesser percentage of poly[2,2-bistrifluoromethyl-4,5-difluoro-1,3-dioxole-co-tetrafluoroethylene] than the first cladding layer, the waveguide core having a second refractive index greater than the first refractive index by not more than one percent; and disposing a second cladding layer disposed on the waveguide core the cladding layer including poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene], the second cladding layer having a greater percentage of poly[2,2-bistrifluoromethyl-4,5-difluoro-1,3-dioxole-co-tetrafluoroethylene] than the waveguide core, the second cladding layer having a third refractive index less than the second refractive index by less than one percent.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a graph of blend percentages of HYFLON® AD60 and TEFLON® AF by weight vs. the resulting refractive index of the blend at various wavelengths.

FIG. 2 is a graph of blend percentages of HYFLON® AD60 and TEFLON® AF by weight vs. the resulting T_{g} of the blend.

FIG. 3 is a perspective view, in partial section, of optical fibers coupled to opposing ends of a waveguide using a blend according to the present invention.

FIG. 4 is a perspective view of an optical fiber fabricated using a blend according to the present invention.

### DETAILED DESCRIPTION OF THE INVENTION

A first embodiment of the present invention comprises a blend of the perfluoropolymer poly[2,2-bistrifluoromethyl-4,5-difluoro-1,3-dioxole-co-tetrafluoroethylene], which is sold under the trademark TEFLON® AF and poly[2,2,4-trifluoro-5-trifluoromethoxy-1,3-dioxole-co-tetrafluoroethylene] which is sold under the trademark HYFLON® AD60 (“HYFLON®”). TEFLON® AF has a refractive index of approximately 1.298 at 1550 nanometers and HYFLON® has a refractive index of approximately 1.313 at 1550 nanometers. A blend of TEFLON® AF and HYFLON provides a refractive index between approximately 1.298 and 1.313. The first embodiment of the present invention provides a blend of TEFLON® AF and HYFLON® in predetermined ratios by weight to achieve a desired refractive index of between 1.298 and 1.313 (at 1550 nanometers). The resulting miscible blend is an amorphous perfluoropolymer capable of guiding light in an optical waveguide.

Both TEFLON® AF and HYFLON® are fairly soluble in perfluorinated solvents such as perfluoro (2-butyltetrahydrofuran), which is sold under the trademark FC-75, as well as N, N-Dimethylacetamide (DMAC) and perfluoro trialkylamine, which is sold under the trademark FC-40. Other potential solvents are a perfluorinated polyether, such as that sold under the trademark H GALDEN® series HT170, or a hydrofluoropolyether, such as that sold under the trademarks H GALDEN® series ZT180 and ZT130. Such solubility allows for easy blending of TEFLON® AF and HYFLON®.

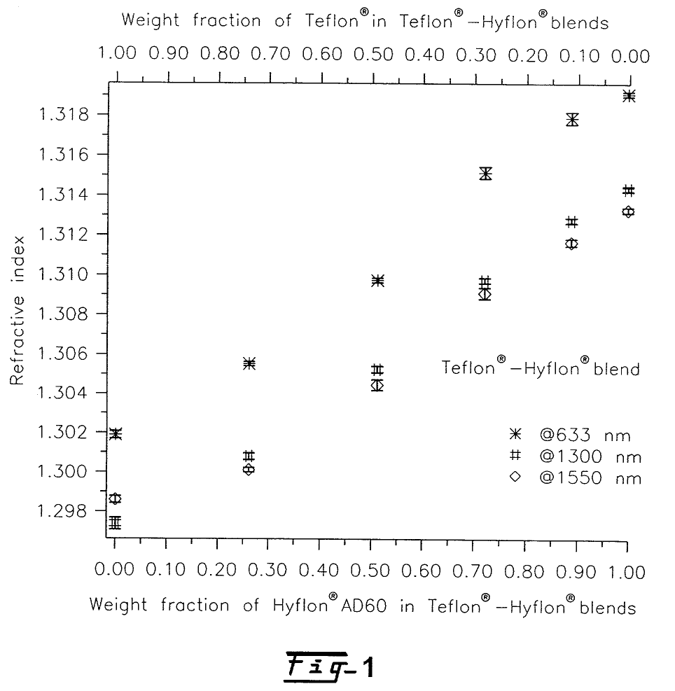

FIG. 1 shows results of prism coupling measurements of the refractive index using light having wavelengths of 633, 1300, and 1550 nanometers. The results are displayed in the form of a graph of percentages of TEFLON® AF and HYFLON® in a TEFLON® AF/HYFLON® blend vs. resulting refractive index. For 100% TEFLON® AF, refractive indices of approximately 1.302, 1.299 and 1.298 at wavelengths of approximately 633 nanometers, 1300 nanometers, and 1550 nanometers, respectively, were measured. For blends of HYFLON® with TEFLON® AF, increasing refractive indices with increased weight percentages of HYFLON® at wavelengths of approximately 633 nanometers, 1300 nanometers, and 1550 nanometers, respectively, were measured. For example, for a blend with a 3 to 1 ratio of TEFLON® AF to HYFLON®, refractive indices of approximately 1.306, 1.301, and 1.300 at wavelengths of approximately 633 nanometers, 1300 nanometers, and 1550 nanometers, respectively, were measured. For a blend with a 1 to 1 ratio of TEFLON® AF to HYFLON®, refractive indices of approximately 1.310, 1.305, and 1.304 at wavelengths of approximately 633 nanometers, 1300 nanometers, and 1550 nanometers, respectively, were measured. For 100% HYFLON®, refractive indices of approximately 1.319, 1.314, and 1.313 at wavelengths of approximately 633 nanometers, 1300 nanometers, and 1550 nanometers, respectively, were measured. FIG. 1 clearly shows that the refractive index of the blend can be varied between that of the pure perfluoropolymer TEFLON® AF and HYFLON® by a small enough amount to enable the fabrication of single-mode optical waveguides large enough to provide for adequate coupling to a single mode optical fiber.

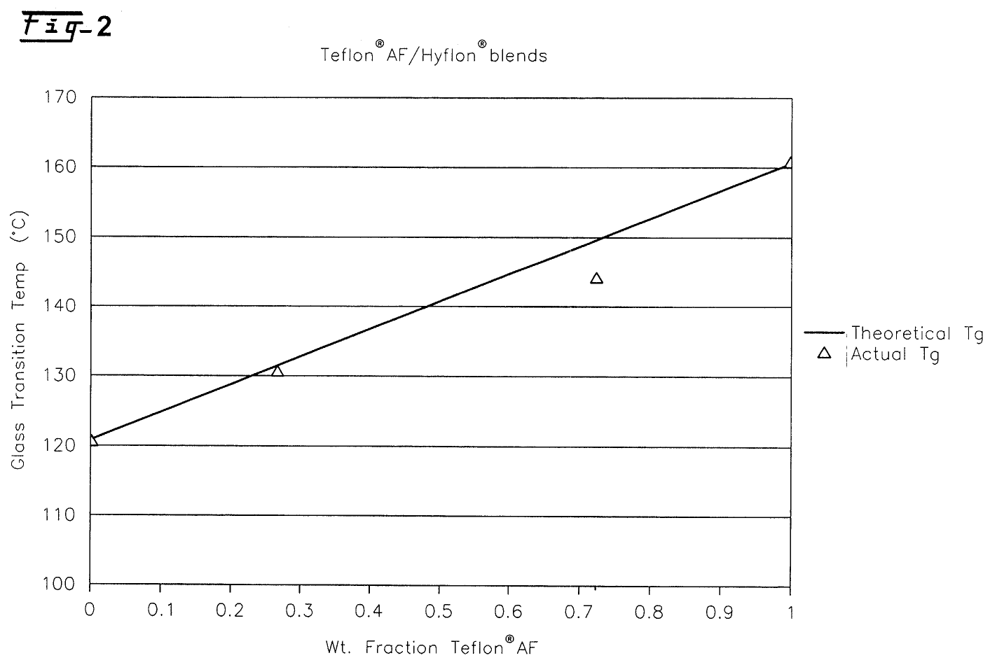

FIG. 2 is a graph of HYFLON® AD60 and TEFLON® AF blended in various percentages vs. the glass transition temperature (T_{g}) of the blends. As can be seen, a single T_{g} is exhibited, which increases with increased amount of TEFLON® AF in the blend, indicating that the polymers are truly miscible.

A method of manufacturing the blend will now be described.

### EXAMPLE

A 4.2% solution of TEFLON® AF 1600 was made in a 4 to 1 mixture of FC-40 and FC-75, respectively, by mixing the constituents in a glass vial and stirring on a hot plate until the solid was completely dissolved. The resulting solution was cooled and filtered through a glass microfiber filter into a clean glass vial. A solution of 20% by weight of HYFLON® was made in FC 75 by mixing the constituents in a glass vial and stirring on a hot plate until the solid was completely dissolved. The resulting solution was cooled and filtered through a glass microfiber filter into a clean glass vial. The filtered HYFLON® solution was added to the filtered TEFLON® AF solution, such that the desired weight ratio of HYFLON® to TEFLON® AF was present. The resulting mixture was warmed slightly with stirring for approximately two hours and filtered through a glass microfiber filter into another clean glass vial. The resulting solution was spin coated onto an SC-1 cleaned 3 inch silicon wafer at a spin speed of approximately 1000 RPM for 10 seconds. The film was then heated at 60° C. for 15 minutes, 80° C. for 10 minutes, and finally, 170° C. for 30 minutes. The resulting films were interrogated by visual inspection, adhesion testing, and optical prism coupling, which yielded information about the refractive index and also the thickness of the film.

The present invention provides the ability to choose the refractive index of core and cladding layers in an optical waveguide anywhere from approximately 1.297 to 1.313 (at 1550 nanometers) as shown in FIG. 1, by making blends of the aforementioned materials with HYFLON® and TEFLON® AF. By making such blends, core and cladding layers can be made with refractive indices that are close together, thereby providing for single-mode waveguides of larger dimensions. Referring to Equation 1, substituting HYFLON® as the cladding layer in place of CYTOP® decreases (n²_{core}−n²_{clad}) and allows one to increase the single-mode cutoff thickness to 3.4 μm, taking the refractive index of HYFLON® to be approximately 1.313 at 1550 nanometers. Blends in the core layer further decrease the refractive index difference between the core layer and the cladding layer, allowing further increases in the thickness of the core, and therefore, better coupling to, an optical fiber.

A number of waveguides can be made by using appropriate blends of TEFLON® AF/HYFLON® for core and cladding layers. In the present invention, a variety of blends were made using 8 weight % TEFLON® AF in a 4 to 1 solution of FC-40 to FC-75 as solvent and 20 weight % HYFLON® in FC-75. Different blend percentages were made by mixing appropriate amounts of each kind of solution. After mixing, the blends were stirred for about 2 hours before spin coating on silicon wafer. Refractive index and thickness of the spun films were measured at three different wavelengths of approximately 633 nanometers, 1300 nanometers, and 1550 nanometers as shown in FIG. 1 and as described above. The films having TEFLON® AF to HYFLON® ratios of 3 to 1 and 1 to 1 were spin-coated twice to get film thickness above 3 μm.

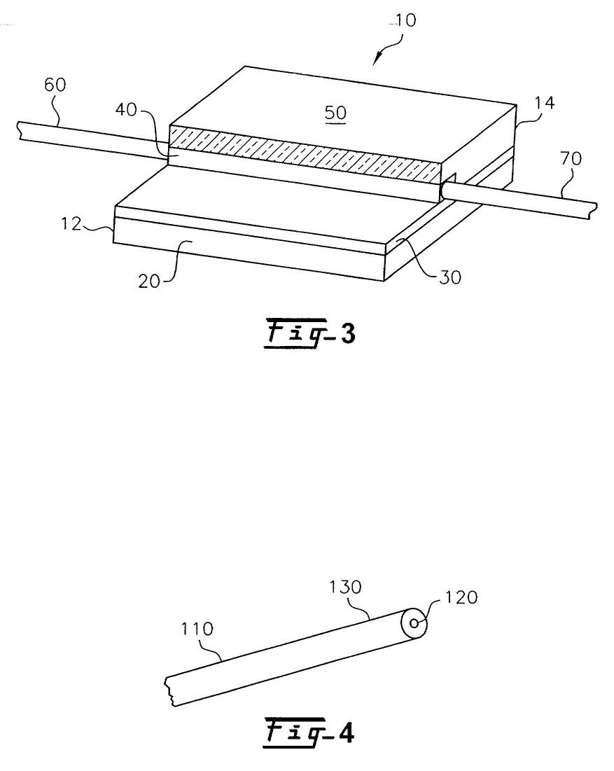

An embodiment of the invention is shown in FIG. 3. An optical waveguide 10 has a first end 12 and a second end 14. The waveguide 10 is comprised of a substrate 20. A first, or lower cladding layer 30 is disposed on the substrate 20. The lower cladding layer 30 can be comprised of, for example, 100% TEFLON® AF, which, according to the graph of FIG. 1 at a wavelength of 1550 nanometers, has a refractive index of approximately 1.298. A waveguide core 40 is disposed over the lower cladding layer 30. The waveguide core 40 is formed by methods which are well known to those skilled in the art, such as, for example, by conventional very large scale integration (VLSI) techniques, which include reactive ion etching and direct electron beam writing, as well as other methods, such as laser ablation, molding, embossing, and diffusion. Those skilled in the art will recognize that such methods are not limiting, as other known methods can be used as well.

Preferably, the waveguide core 40 has a refractive index which differs from the refractive index of the lower cladding layer 30 by less than one percent, such as, in this example, approximately 1.310. Referring to FIG. 1, a blend of HYFLON® with the TEFLON® AF in a weight ratio of approximately 71% HYFLON® and 29% TEFLON® AF at a wavelength of 1550 nanometers yields a desired refractive index of approximately 1.309. A second, or top cladding layer 50, comprised of 100% TEFLON® AF is disposed over the waveguide core 40 such that the waveguide core 40 is completely surrounded by cladding layers comprised of 100% TEFLON® AF, except on the ends 12, 14. The cladding layers 30, 50 can be formed by any of known methods, including, but not limited to, spin coating, casting, or doctor blading. A fiber 60 is attached to the waveguide core 40 at the first end 12 so that light from the fiber 60 enters the waveguide core 40 and is guided in the waveguide core 40 between the bottom and top cladding layers 30, 50, which guide the light to a fiber 70 at the second end 14 of the waveguide 10. Preferably, the fibers 60, 70 are attached to the waveguide core 40 by known methods, such as by the use of capillaries or ferrules and ultraviolet or thermally curing epoxies, as well as other methods.

Although, in the embodiment described above, the top and bottom cladding layers 30, 50 comprise 100% TEFLON® AF and the waveguide core 40 comprises approximately 70% HYFLON® and 30% TEFLON® AF, those skilled in the art will recognize that other blend percentages for both the core 40 and the cladding layers 30, 50 can be used, so long as the refractive index difference Δn between the cladding layers 30, 50 and the waveguide core 40 is within the desired range. Preferably, the cladding layers 30, 50 have the same refractive index, resulting in a symmetric waveguide 10, which reduces or eliminates effects such as polarization dependent loss.

Alternatively, the waveguide core 40 can be comprised of an alternate perfluoropolymer, such as poly[2,3-perfluoroalkenyl) perfluorotetrahydrofuran], which is sold under the trademark CYTOP®. The cladding layers 30, 50, can be TEFLON® AF, HYFLON®, or a TEFLON® AF/HYFLON® blend as described above.

The waveguide 10 described above is preferably used for single-mode light propagation. However, those skilled in the art will recognize that, by increasing the refractive index difference Δn so that the refractive index of the waveguide core 40 is at least 2 percent greater than the refractive index of the top and bottom cladding layers 30, 50, the waveguide 10 can be used for multimode light propagation as well.

Alternatively, the present invention comprises a blend of TEFLON® AF and HYFLON® with a rare earth doped fluoropolymer, such as the rare earth doped fluoropolymers described in U.S. Pat. No. 6,292,292; U.S. patent application Ser. Nos. 09/722,821, filed Nov. 28, 2000; and 09/722,822, filed Nov. 28, 2000, all of which are owned by the assignee of the present invention and are incorporated by reference herein in their entireties. The rare earth doped fluoropolymer preferably has a general composition of {X[DDZRR′]₃}ₙ or {XY[DDZRR′]₃}ₙ where X is a first rare earth element, Y is a second rare earth element or aluminum, D is an element from Group VI_{A} of the Periodic Table, Z is an element from Group V_{A} of the Periodic Table, R is a first fully halogenated organic group, R′ is a second fully halogenated organic group, and n is a whole number greater than or equal to 1. The first and second rare earth elements are preferably from the group consisting of lanthanum, cerium, praseodymium, neodymium, promethium, samarium, europium, gadolinium, terbium, dysprosium, holmium, erbium, thulium, ytterbium, and lutetium. All other rare earth elements are also within the contemplation of the invention and are not intended to be excluded.

Blends using various percentages of TEFLON® AF, HYFLON®, and the rare earth doped fluoropolymer can be used to form the waveguide core 40. Alternatively, the waveguide core can be a blend of the rare earth doped fluoropolymer and CYTOP®. Those skilled in the art will recognize that, by using a blend with the rare earth doped polymer in the waveguide core 40, the waveguide 10, in conjunction with a pump laser, can act as an optical amplifier.

To manufacture the embodiment of the present invention with the rare earth doped perfluoropolymer, the rare earth doped perfluoropolymer is dissolved in a solvent, such as DMAC, FC-75, FC-40, or a mixture thereof, to form a rare earth doped perfluoropolymer solution. The rare earth doped perfluoropolymer solution is added to the TEFLON® AF/HYFLON® solution described above. The resulting TEFLON® AF/HYFLON® rare earth doped perfluoropolymer mixture can then be warmed slightly with stirring for approximately 30 minutes and filtered through a glass microfiber filter into another clean glass vial. The mixture can then be spin coated onto the lower cladding layer 30 and processed according to the known techniques as described above to form the waveguide core 40.

Although, as described above, the TEFLON® AF and HYFLON® blend can be used to construct a planar waveguide, the ductility of the blend allows the blend to be drawn into an optical fiber 110, as shown in FIG. 4. The fiber 110 includes a core 120 and a cladding 130 which are preferably constructed from TEFLON® AF and HYFLON® as described above with regard to the core 40 and the claddings 30, 50.

Further, although HYFLON® AD60 was used in the applications described above, those skilled in the art will recognize that HYFLON® AD40 and/or HYFLON® AD80 can be used instead, with similar results.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A polymer blend comprising:
poly[2,2-bistrifluoromethyl-4,5-difluoro-1,3-dioxole-co-tetrafluoroethylene]; and
poly[2,2,4-trifluoro-5-trifluoromethoxy-1,3-dioxole-co-tetrafluoroethylene].

2. The polymer blend according to claim 1, wherein a ratio of poly[2,2-bistrifluoromethyl-4,5-difluoro-1,3-dioxole-co-tetrafluoroethylene] to poly[2,2,4-trifluoro-5-trifluoromethoxy-1,3-dioxole-co-tetrafluoroethylene] is approximately 3 to 1 by weight.

3. The polymer blend according to claim 2, wherein a refractive index of the blend is approximately 1.300 at a wavelength of approximately 1550 nanometers.

4. The polymer blend according to claim 1, wherein a ratio of poly[2,2-bistrifluoromethyl-4,5-difluoro-1,3-dioxole-co-tetrafluoroethylene] to poly[2,2,4-trifluoro-5-trifluoromethoxy-1,3-dioxole-co-tetrafluoroethylene] is approximately 1 to 1 by weight.

5. The polymer blend according to claim 4, wherein a refractive index of the blend is approximately 1.304 at a wavelength of approximately 1550 nanometers.

6. The polymer blend according to claim 1, wherein the blend is an amorphous perfluoropolymer.

7. The polymer blend according to claim 1, further comprising a rare earth doped fluoropolymer.

8. The polymer blend according to claim 1, wherein a weight percentage of between 5% and 95% of poly[2,2-bistrifluoromethyl-4,5-difluoro-1,3-dioxole-co-tetrafluoroethylene] yields a refractive index of between approximately 1.299 and 1.313 at a wavelength of approximately 1550 nanometers.

9. The polymer blend according to claim 1, wherein a weight percentage of between 5% and 95% of poly[2,2-bistrifluoromethyl-4,5-difluoro-1,3-dioxole-co-tetrafluoroethylene] yields a glass transition temperature of between approximately 122 and 158 degrees Celsius.

10. A method of manufacturing a polymer blend comprising:
providing a mixture of perfluoro trialkylamine and perfluoro (2-butyltetrahydrofuran) in approximately a 4 to 1 ratio;
combining with the mixture solid poly[2,2-bistrifluoromethyl-4,5-difluoro-1,3-dioxole-co-tetrafluoroethylene] to form a 4.2% by weight poly[2,2-bistrifluoromethyl-4,5-difluoro-1,3-dioxole-co-tetrafluoroethylene] solution;
stirring the poly[2,2-bistrifluoromethyl-4,5-difluoro-1,3-dioxole-co-tetrafluoroethylene] solution over heat until the solid completely dissolves;
cooling the poly[2,2-bistrifluoromethyl-4,5-difluoro-1,3-dioxole-co-tetrafluoroethylene] solution;
filtering the poly[2,2-bistrifluoromethyl-4,5-difluoro-1,3-dioxole-co-tetrafluoroethylene] solution;
providing poly[2,2,4-trifluoro-5-trifluoromethoxy-1,3-dioxole-co-tetrafluoroethylene] in perfluoro 2-butyltetrahydrofuran to form a 10.2% by weight poly[2,2,4-trifluoro-5-trifluoromethoxy-1,3-dioxole-co-tetrafluoroethylene] solution; and
adding the poly[2,2,4-trifluoro-5-trifluoromethoxy-1,3-dioxole-co-tetrafluoroethylene] solution to the poly[2,2-bistrifluoromethyl-4,5-difluoro-1,3-dioxole-co-tetrafluoroethylene] solution.

11. The method according to claim 10, wherein adding the poly[2,2,4-trifluoro-5-trifluoromethoxy-1,3-dioxole-co-tetrafluoroethylene] solution to the poly[2,2-bistrifluoromethyl-4,5-difluoro-1,3-dioxole-co-tetrafluoroethylene] solution is performed such that a weight ratio of the poly[2,2,4-trifluoro-5-trifluoromethoxy-1,3-dioxole-co-tetrafluoroethylene] solution to the poly[2,2-bistrifluoromethyl-4,5-difluoro-1,3-dioxole-co-tetrafluoroethylene] solution is between one to three and three to one.

12. The method according to claim 10, further comprising, after adding the poly[2,2,4-trifluoro-5-trifluoromethoxy-1,3-dioxole-co-tetrafluoroethylene] solution to the poly[2,2-bistrifluoromethyl-4,5-difluoro-1,3-dioxole-co-tetrafluoroethylene] solution, stirring the resulting blend.

13. The method according to claim 10, wherein providing the mixture comprises providing the mixture in a glass vial.

14. A polymer blend comprising:
poly[2,2-bistrifluoromethyl-4,5-difluoro-1,3-dioxole-co-tetrafluoroethylene]; and
poly[2,2,4-trifluoro-5-trifluoromethoxy-1,3-dioxole-co-tetrafluoroethylene], wherein the polymer blend is manufactured by:
providing a mixture of perfluoro trialkylamine and perfluoro(2-butyltetrahydrofuran) in approximately a 4 to 1 ratio;
combining with the mixture solid poly[2,2-bistrifluoromethyl-4,5-difluoro-1,3-dioxole-co-tetrafluoroethylene] to form a 4.2% by weight poly[2,2-bistrifluoromethyl-4,5-difluoro-1,3-dioxole-co-tetrafluoroethylene] solution;
stirring the poly[2,2-bistrifluoromethyl-4,5-difluoro-1,3-dioxole-co-tetrafluoroethylene] solution over heat until the solid completely dissolves;
cooling the poly[2,2-bistrifluoromethyl-4,5-difluoro-1,3-dioxole-co-tetrafluoroethylene] solution;
filtering the poly[2,2-bistrifluoromethyl-4,5-difluoro-1,3-dioxole-co-tetrafluoroethylene] solution;
providing the poly[2,2,4-trifluoro-5-trifluoromethoxy-1,3-dioxole-co-tetrafluoroethylene] to form a 10.2% by weight poly[2,2,4-trifluoro-5-trifluoromethoxy-1,3-dioxole-co-tetrafluoroethylene] solution; and
adding the poly[2,2,4-trifluoro-5-trifluoromethoxy-1,3-dioxole-co-tetrafluoroethylene] solution to the poly[2,2-bistrifluoromethyl-4,5-difluoro-1,3-dioxole-co-tetrafluoroethylene] solution.

15. An optical waveguide comprising:
a substrate;
a first cladding layer disposed on the substrate, the first cladding layer including between greater than zero and up to and including 100 percent of poly[2,2-bistrifluoromethyl-4,5-difluoro-1,3-dioxole-co-tetrafluoroethylene] and a remaining percent poly[2,2,4-trifluoro-5-trifluoromethoxy-1,3-dioxole-co-tetrafluoroethylene], the first cladding layer having a first refractive index;
a waveguide core disposed on the substrate, the waveguide core having a second refractive index greater than the first refractive index; and
a second cladding layer disposed on the waveguide core, the second cladding layer including between greater than zero and up to and including 100 percent of poly[2,2-bistrifluoromethyl-4,5-difluoro-1,3-dioxole-co-tetrafluoroethylene] and a remaining percent poly[2,2,4-trifluoro-5-trifluoromethoxy-1,3-dioxole-co-tetrafluoroethylene], the second cladding layer having a third refractive index less than the second refractive index.

16. The optical waveguide according to claim 15, wherein the difference between the first refractive index and the second refractive index is less than or equal to one percent.

17. The optical waveguide according to claim 15, wherein the first cladding layer is comprised of approximately the same percentage of poly[2,2-bistrifluoromethyl-4,5-difluoro-1,3-dioxole-co-tetrafluoroethylene] as the second cladding layer.

18. The optical waveguide according to claim 15, wherein the first cladding layer is comprised of 100% poly[2,2-bistrifluoromethyl-4,5-difluoro-1,3-dioxole-co-tetrafluoroethylene].

19. The optical waveguide according to claim 15, wherein the waveguide core is comprised of a blend of poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene].

20. The optical waveguide according to claim 15, wherein the first cladding layer is comprised of a blend of poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene].

21. The optical waveguide according to claim 20, wherein the waveguide core is comprised of a blend of poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene], the waveguide core having a higher weight percentage of poly[2,2,4-trifluoro-5-trifluoromethoxy-1,3-dioxole-co-tetrafluoroethylene] than the first cladding layer.

22. The optical waveguide according to claim 15, wherein the optical waveguide directs single-mode light.

23. The optical waveguide according to claim 15, wherein the waveguide core is comprised of 100% poly[2,2,4-trifluoro-5-trifluoromethoxy-1,3-dioxole-co-tetrafluoroethylene].

24. The optical waveguide according to claim 15, wherein the first cladding layer is comprised of 100% poly[2,2-bistrifluoromethyl-4,5-difluoro-1,3-dioxole-co-tetrafluoroethylene].

25. The optical waveguide according to claim 15, wherein the waveguide core is comprised of poly[2,2,4-trifluoro-5-trifluoromethoxy-1,3-dioxole-co-tetrafluoroethylene].

26. The optical waveguide according to claim 25, wherein the waveguide core is further comprised of a rare earth doped fluoropolymer.

27. The optical waveguide according to claim 15, wherein the waveguide core is further comprised of a rare earth doped fluoropolymer.

28. A method of manufacturing an optical waveguide comprising:
providing a substrate;
disposing a first cladding layer onto the substrate, the first cladding layer including between greater than 0% and up to and including 100% poly[2,2-bistrifluoromethyl-4,5-difluoro-1,3-dioxole-co-tetrafluoroethylene] and the remaining poly[2,2,4-trifluoro-5-trifluoromethoxy-1,3-dioxole-co-tetrafluoroethylene], the first cladding layer having a first refractive index;
disposing a waveguide core onto the substrate, the waveguide core having a lesser percentage of poly[2,2-bistrifluoromethyl-4,5-difluoro-1,3-dioxole-co-tetrafluoroethylene] than the first cladding layer, the waveguide core having a second refractive index greater than the first refractive index by not more than one percent; and
disposing a second cladding layer disposed on the waveguide core the cladding layer including poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene], the second cladding layer having a greater percentage of poly[2,2-bistrifluoromethyl-4,5-difluoro-1,3-dioxole-co-tetrafluoroethylene] than the waveguide core, the second cladding layer having a third refractive index less than the second refractive index by less than one percent.

29. An optical waveguide comprising:
a cladding layer including between greater than zero and up to and including 100 percent of poly[2,2-bistrifluoromethyl-4,5-difluoro-1,3-dioxole-co-tetrafluoroethylene] and a remaining percent poly[2,2,4-trifluoro-5-trifluoromethoxy-1,3-dioxole-co-tetrafluoroethylene], the cladding layer having a first refractive index; and
a waveguide core disposed within the cladding layer, the waveguide core being comprised of a blend of poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene].

30. The optical waveguide according to claim 29, wherein the difference between the first refractive index and the second refractive index is less than or equal to one percent.

31. The optical waveguide according to claim 29, wherein the cladding layer is comprised of 100% poly[2,2-bistrifluoromethyl-4,5-difluoro-1,3-dioxole-co-tetrafluoroethylene].

32. The optical waveguide according to claim 29, wherein the cladding layer is comprised of a blend of poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene].

33. The optical waveguide according to claim 32 wherein the waveguide core is comprised of a blend of poly[2,2-bistrifluoromethyl-4,5-difluoro-1,3-dioxole-co-tetrafluoroethylene] and poly[2,2,4-trifluoro-5-trifluoromethoxy-1,3-dioxole-co-tetrafluoroethylene], the waveguide core having a higher weight percentage of poly[2,2,4-trifluoro-5-trifluoromethoxy-1,3-dioxole-co-tetrafluoroethylene] than the cladding layer.

34. The optical waveguide according to claim 29, wherein the optical waveguide directs single-mode light.

35. The optical waveguide according to claim 29, wherein the waveguide core is comprised of 100% poly[2,2,4-trifluoro-5-trifluoromethoxy-1,3-dioxole-co-tetrafluoroethylene].

36. The optical waveguide according to claim 29, wherein the cladding layer is comprised of 100% poly[2,2-bistrifluoromethyl-4,5-difluoro-1,3-dioxole-co-tetrafluoroethylene].

37. The optical waveguide according to claim 29, wherein the waveguide core is comprised of poly[2,2,4-trifluoro-5-trifluoromethoxy-1,3-dioxole-co-tetrafluoroethylene].

38. The optical waveguide according to claim 37, wherein the waveguide core is further comprised of a rare earth doped fluoropolymer.

39. The optical waveguide according to claim 29, wherein the waveguide core is further comprised of a rare earth doped fluoropolymer.
